(19) United States
(12) Patent Application Publication
(10) Pub. No.: US 2014/0051057 A1
(43) Pub. Date: Feb. 20, 2014

(54) DISPOSABLE AND/OR RECYCLABLE COMBINATION LOCK AND METHOD OF USE

(71) Applicants: Sahar D. Nowrouzzadeh, Olney, MD (US); Mazdak Taghioskoui, Olney, MD (US)

(72) Inventors: Sahar D. Nowrouzzadeh, Olney, MD (US); Mazdak Taghioskoui, Olney, MD (US)

(21) Appl. No.: 13/586,860

(22) Filed: Aug. 15, 2012

(51) Int. Cl. E05B 37/12; G09B 25/00

(52) U.S. Cl. 434/365; 70/332

(57) ABSTRACT

a disposable and/or recyclable combination lock comprises: a plurality of combination dials that lock or unlock the disposable and/or recyclable combination lock, each one of the plurality of combination dials having a corresponding unlocking dial position and being rotatably adjustable to its corresponding unlocking dial position; and a locking latch plate including a plurality of locking latches that is movable between a locked position and an unlocked position, such that the disposable and/or recyclable combination lock is attached to a disposable and/or recyclable lockable article including a plurality of locking latch plate holes, an interior region, and a lockable lid, the disposable and/or recyclable combination lock has a substantially flat geometry, and the disposable and/or recyclable combination lock is made of recyclable and/or disposable materials.

### FIELD OF THE INVENTION

The present application relates to a disposable and recyclable combination lock having flat geometry, and more particularly, a disposable and recyclable combination lock having flat geometry that can be integrated with, attached to, or assembled on a disposable and recyclable article such as a box, a mailer, an envelope, a container, a book, or product packaging.

### BACKGROUND OF THE INVENTION

Combination locks are used in a variety of applications including, for example, high-security safes, luggage, and various gates and doors. A sequence of numbers or symbols are used to unlock the combination lock in order to open a corresponding locked container or box that the combination lock is attached to.

While most combination locks are directed at applications where high security is required, inexpensive combination locks that are produced with disposable and recycled materials are in demand. This application presents a solution to the above-noted problem.

### SUMMARY OF THE INVENTION

A disposable and/or recyclable combination lock is a lock that is made mainly of materials that can be disposed and/or recycled to provide an advantage of cheap manufacturing and short-term durability. For example, the majority of materials that are used to manufacture the disposable and/or recyclable combination lock are made of disposable and recyclable material. For example, 50% or more, preferably 80% or more, and even more preferably 90% or more of the materials that are used to manufacture the disposable and/or recyclable combination lock are made of disposable and recyclable materials. The disposable and/or recyclable combination locks are suitable for a single use, use over a period of few months, or depending on the care and handling, for long term use, after which it is recycled or is disposed of as solid waste. The disposable and/or recyclable combination locks are different from conventional combination locks that last indefinitely and are designed for high security purposes. The disposable and/or recyclable combination lock is mostly aimed towards applications where security is not a major concern, e.g. a user is not concerned to protect the locked materials with what are commonly considered as high security measures. On example of such an application, is providing an item within packaging that utilizes the disposable and/or recyclable combination lock to provide an element of fun and amusement to the consumer by challenging the consumer to unlock the disposable and/or recyclable combination lock. Another exemplary application of the disposable and/or recyclable combination lock is providing boxes of toys or rewards to children and challenging them to unlock the combination lock to open such boxes.

According to some aspects of the present application, the disposable and/or recyclable combination lock can be integrated with a box, package, container and similar articles that are made from disposable and/or recyclable materials.

It is an object of this application to provide a planar and flat combination lock that can be made with cutting sheets of disposable and/or recyclable materials.

It is an object of this application to provide methods to use the combination locks that are manufactured with a simple and low-cost die cutting procedure.

It is an object of this application to manufacture packaging with recyclable and disposable combination locks assembled to them.

It is an object of this application to manufacture packaging with recyclable and disposable combination locks assembled on them and that each combination dial provides a clue for unlocking the next combination dial.

According to some aspects of the present application, a disposable and/or recyclable combination lock comprises: a plurality of combination dials that lock or unlock the disposable and/or recyclable combination lock, each one of the plurality of combination dials having a corresponding unlocking dial position and being rotatably adjustable to its corresponding unlocking dial position; and a locking latch plate including a plurality of locking latches that is movable between a locked position and an unlocked position when all of the plurality of combination dials are in their corresponding unlocking dial positions, and is fixed and non-movable in a locked position when at least one of the plurality of combination dials is in its corresponding unlocking dial position, wherein the disposable and/or recyclable combination lock is attached to a disposable and/or recyclable lockable article including a plurality of locking latch plate holes, an interior region, and a lockable lid, the plurality of locking latches of the locking latch plate in the locked position are engaged with the plurality of locking latch plate holes and prevent the lockable lid from being opened to gain access to the interior region, and the plurality of locking latches of the locking latch plate in the unlocked position are not engaged with the plurality of locking latch plate holes and allow the lockable lid for being opened to gain access to the interior region, the disposable and/or recyclable combination lock has a substantially flat geometry, and the disposable and/or recyclable combination lock is made of recyclable and/or disposable materials.

According to some aspects of the present application, the locking latch plate further includes a plurality of combination disc cuts that provide a plurality of empty spaces on the locking latch plate and a plurality of tongues on the locking latch plate.

According to some aspects of the present application, the combination lock further comprises: a plurality of combination discs, each one of the plurality of combination discs having a notch is placed inside its corresponding combination disc cut and is connected to its corresponding combination dial from the plurality of combination dials such that a rotation of each one of the plurality of combination dials rotates each corresponding combination disc simultaneously and in synchrony; a locking latch plate knob that is used as a handle to move the locking latch plate between the locked position and the unlocked position; an outer case that provides an axial path for the locking latch plate to move between the locked position and the unlocked position and retains the locking latch plate in the axial path; and a spring element between the outer case and the locking latch plate that forces the locking latch plate into the locked position, wherein in the unlocking dial position the notch of each one of the plurality of combination discs fits into the tongue of each corresponding combination disc cuts when the locking latch plate is moved to the unlocked position, and in positions other than the unlocking dial position the tongue of the each of the plurality of combination disc cuts prevents the locking latch plate from moving to the unlocked position.

According to some aspects of the present application, the combination lock further comprises a back cover plate that sandwiches the locking latch plate, the plurality of combination discs, the outer case, and the spring element between the lockable lid and the back cover plate, wherein the outer case is fixed between the back cover plate and the lockable lid, the locking latch plate is movable between the locked position and the unlocked position in the axial path, and each of the plurality of combination discs freely rotates around each of a plurality of combination disc holes.

According to some aspects of the present application, the locking latch plate, the plurality of combination dials, the plurality of combination discs, and the outer case are made of recyclable and/or disposable materials and are of a same predetermined thickness.

According to some aspects of the present application, the combination dials have a substantially circular geometry.

According to some aspects of the present application, each of the plurality of combination dials are connected to corresponding combination disc with a rotating shaft.

According to some aspects of the present application, the unlocking dial position of at least one of the plurality of combination dials provides a clue for another unlocking dial position of another combination dial of the plurality of combination dials.

According to some aspects of the present application, a disposable and/or recyclable combination lock comprises: a first layer including: a locking latch plate having a plurality of locking latches and a plurality of locking latch plate cuts, a plurality of combination discs, an outer case, and a spring element; a second layer including: a front cover plate having a plurality of front cover plate holes and a front cover slot; and a third layer including: a back cover plate, wherein the first layer is sandwiched between the second layer and the third layer, the disposable and/or recyclable combination lock is attachable from the second layer to a lockable lid of an article having a plurality of locking latch plate holes and an interior region that is accessed by removing the lockable lid, each one of a plurality of combination dials are connected to its corresponding combination disc via each one of a plurality of rotating shafts, the disposable and/or recyclable combination lock has a substantially flat geometry, and the disposable and/or recyclable combination lock is made of recyclable and/or disposable materials.

According to some aspects of the present application the locking latch plate, the plurality of combination dials, the plurality of combination discs, and the outer case are of a same predetermined thickness.

According to some aspects of the present application, the unlocking dial position of at least one of the plurality of combination dials provides a clue for another unlocking dial position of another combination dial of the plurality of combination dials.

According to some aspects of the present application, a method for accessing a plurality of items in the interior region of the disposable and/or recyclable lockable article locked with the disposable and/or recyclable combination lock comprises: providing the disposable and/or recyclable lockable article locked with the disposable and/or recyclable combination lock that includes the plurality of items in the interior region to a user; providing a book or a plurality of flash cards to the user; finding a plurality of clues by the user in the book or the plurality of flash cards; adjusting the plurality of combination dials to the unlocking position based on the plurality of clues; opening the lockable lid of the disposable and/or recyclable article; and accessing the plurality of items in the disposable and/or recyclable lockable article.

The foregoing and additional objects and advantages of the invention, together with the structure characteristics thereof, which were only briefly summarized in the foregoing passages, will become more apparent to those skilled in the art upon reading the detailed description of a preferred embodiment of the invention, which follows in this specification, taken together with the illustrations thereof presented in the accompanying drawings. It should be noted that “plurality” is defined as “one or more” throughout this application.

### BRIEF DESCRIPTION OF THE DRAWINGS

Further features and advantages of the disposable and/or recyclable combination lock as disclosed in this application will become apparent from the following detailed description made with reference to the accompanying drawings, wherein:

FIG. 1 is a top plan view of a disposable and recyclable combination lock in a locked position in accordance with present application;

FIG. 2 is a top plan view of a disposable and recyclable combination lock in a locked and ready to be unlocked position in accordance with present application;

FIG. 3 is a top plan view of a disposable and recyclable combination lock in an unlocked position in accordance with present application;

FIG. 4 is a top plan view of an external lid that a disposable and recyclable combination lock can be assembled on in accordance with present application;

FIG. 5 is a top plan view of an external lid after assembling a disposable and recyclable combination lock in accordance with present application;

FIG. 6 is a perspective and fragmentary view of a disposable and recyclable combination lock in accordance with present application;

FIG. 7 is a perspective and fragmentary view of a disposable and recyclable combination lock with a front cover plate in accordance with present application;

FIG. 8 is a perspective view of a container after assembling a disposable and recyclable combination lock in accordance with present application;

FIG. 9 is a perspective view of compact disc case after assembling a disposable and recyclable combination lock in accordance with present application;

FIG. 10 is a perspective view of an envelope after assembling a disposable and recyclable combination lock in accordance with present application;

FIG. 11 is a perspective and fragmentary view of a combination dial, a combination disc, and a rotating shaft of a disposable and recyclable combination lock in accordance with present application;

FIG. 12 is a perspective and fragmentary view of a combination dial, a combination disc, and a two part rotating shaft of a disposable and recyclable combination lock where the rotating shaft includes a plurality of rotating shaft teeth;

FIG. 13 is a top plan view of a disposable and recyclable combination lock in an unlocked position where elastic or rubber bands are used to force a locking latch plate to the locked position in accordance with present application;

FIG. 14 is a top plan view of an external lid after assembling a disposable and recyclable combination lock with indicia in accordance with present application;

FIG. 15 is a perspective view of a booklet having a plurality of flash cards that each provide a clue to unlock one combination dial of a disposable and/or recyclable combination lock in accordance with present application; and

FIG. 16 is a perspective view of a flash card having a flash card cover to provide clues to unlock a disposable and recyclable combination lock in accordance with present application.

### DETAILED DESCRIPTION OF THE INVENTION

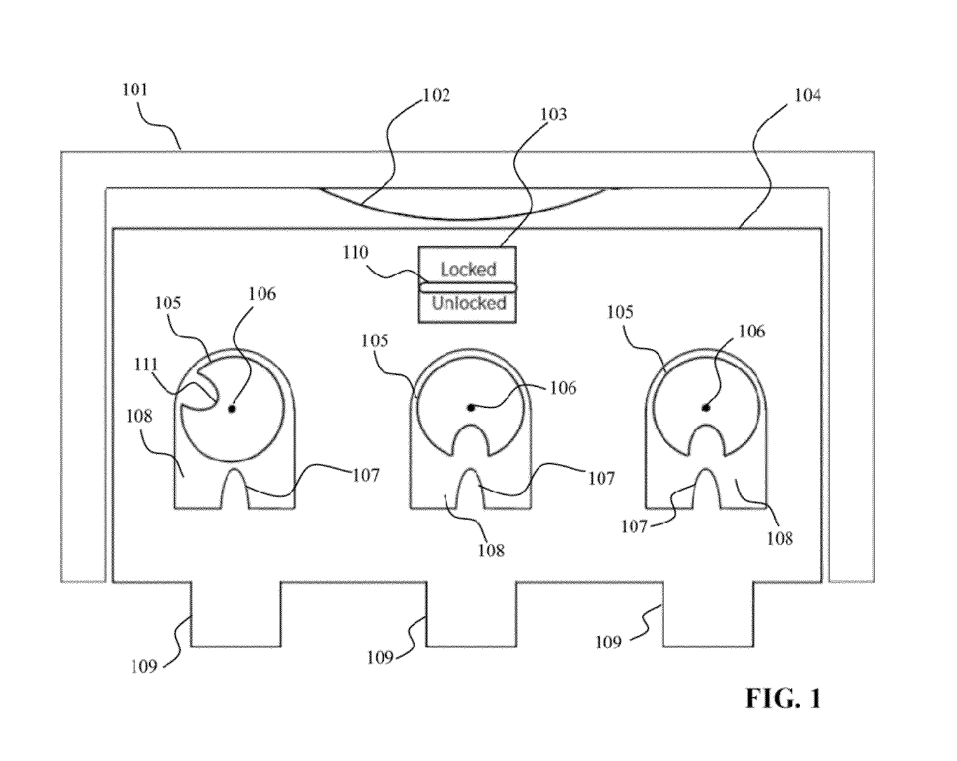

With reference to the drawings, FIG. 1 illustrates an exemplary top plan view of a disposable and recyclable combination lock in a locked position having a substantially planar geometry or flat geometry in accordance with present application. The planar geometry or flat geometry is defined by a geometry in which the thickness is substantially smaller than the width and length. For example a dollar bill, a sheet of paper, or a metal coin of any size all have flat geometry. In planar geometry or flat geometry the length of at least two out of three dimensions (that make the flat or the planar surface) are 5 times or more, preferably 10 times or more, and more preferably 50 times or more of the length of the other dimension (that makes the thickness).

The disposable and/or recyclable combination lock comprises of a locking latch plate 104 that includes a plurality of locking latches 109, a plurality of combination disc cuts 108, a lock status label 103, and a locking latch plate knob 110. The combination lock as described in this application is illustrated in an exemplary embodiment having three combination discs 105. However, the functionality of the disposable and/or recyclable combination lock as described in this application is independent of the number of the combination discs 105. As such, the disposable and/or recyclable combination lock having three combination discs 105 as explained in this application is exemplary and non-limiting. Therefore, the disposable and/or recyclable combination locks having various numbers of combination discs 105 are also in the scope of this application. The combination lock having one to twenty, preferably two to ten, preferably three to five, preferably one to forty, or more preferably, one to one hundred combination discs 105 is also in the scope of this application. Further, it should be noted that each combination disc 105 requires one combination disc cut 108 on the locking latch plate 104. Additionally, the three square-shaped locking latches 109 are described in this application as one exemplary embodiment. The shape or the number of the locking latches 109 can be modified without changing the functionality of the disposable and/or recyclable combination lock as described in this application.

Each combination disc cut 108 is made by cutting the locking latch plate 104 that provides a tongue 107 on the locking latch plate 104. The cutting can be performed by die cutting or similar methods of cutting. Inside the empty area that is made by each combination disc cut 108, a combination disc 105 having a notch 111 is placed that can rotate freely around a combination disc hole 106. The notches 111 and the tongues 107 may have complementary shapes that can fit into each. Other combinations similar to the notches 111 and the tongues 107 that do not have complementary shapes may also be used, for example, half-circular notches 111 with half-oval tongues 107. It should be noted that the half-oval notches 111 and the tongues 107 are exemplary illustrations in this application. But, they can have a half-circular shape, a square shape, or similar shapes that can perform the same functionality of fitting into each other when aligned by sliding and shifting the locking latch plate 104.

An outer case 101 surrounds the locking latch plate 104 to provide an axial path for the locking latch plate 104 to move forward (locked position) and backward (unlocked position) and retains movement of the locking latch plate 104 in a fixed axial position (parallel to the surface of the planar combination lock) to prevent the dislocation of the locking latch plate 104. A spring element 102 is attached to the outer case 101 that forces the locking latch plate 104 forward (locked position). The locking latch plate 104 can move forward and backward within a fixed distance that is limited by the spring element 102 in a fully pressed status and/or movement of the combination disc 105 inside of the combination disc cuts 108. It should be noted that although the outer case 101 provides an axial path for the locking latch plate 104, similar methods, such as providing a plurality of grooves on the locking latch plate 104 (not shown here) can also be used to limit the movement of the locking latch plate 104 to a single axial position or a route (as in drawers) parallel to the substantially flat surface of the combination lock.

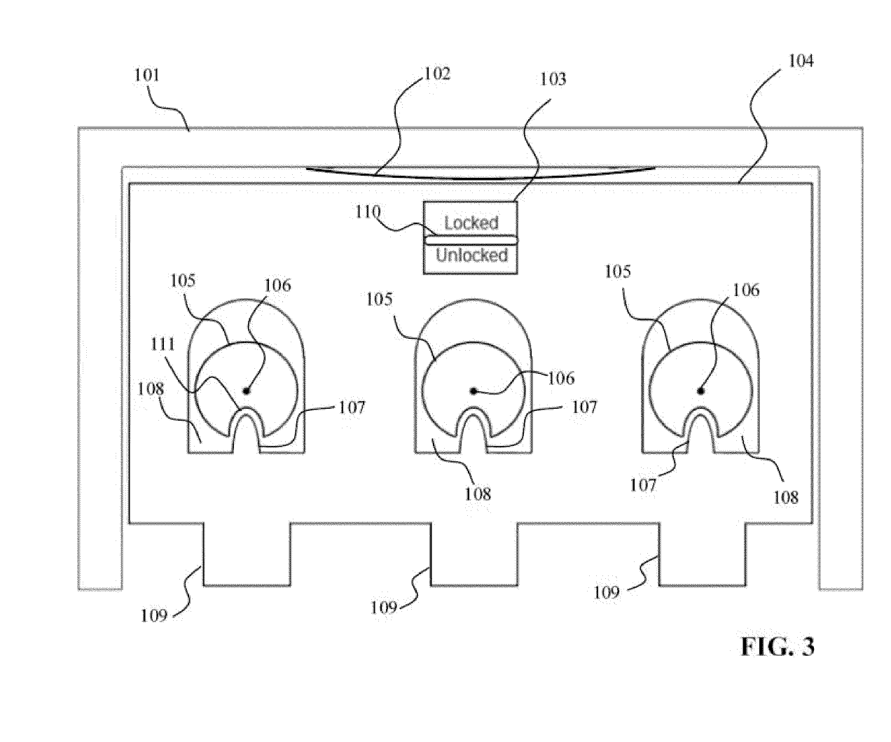

The combination discs 105 can be fixed in the combination disc holes 106 using a plurality of rotating shafts 302 to allow a free rotation the combination discs 105 around the combination disc holes 106. The rotating shafts 302 can be eyelets, two part eyelets, prong eyelets, grommets, grommets with teeth, self-piercing grommets, two-piece grommets or similar pieces that can perform the same function. The unlocked position of the combination lock is achieved when each notch 111 of each combination disc 105 is aligned with each corresponding tongue 107 of the locking latch plate 104 and the locking latch plate 104 is moved to the unlocked position where each notch 111 is fitted to its corresponding tongue 107 as illustrated in FIG. 3. For example, FIG. 1 illustrates the combination lock in the locked position where two of the three notches 111 of the combination discs 105 are aligned with their corresponding tongues 107 (the two on the middle and the right side), but one of the three notches 111 (the one on the left) is not aligned with its corresponding tongue 107. As such, the tongue 107 and the notch 111 that are not aligned prevent the locking latch plate 104 from moving backward (unlocked position) when a user tries to move the locking latch plate 104 to the unlocked position. In this case, the tongue 107 makes contact with the corresponding combination disc 106 in a position other than the notch 111 of the combination disc 106. In the locked position, the locking latches 109 are engaged with a plurality of locking latch holes 601 that are described later in this application.

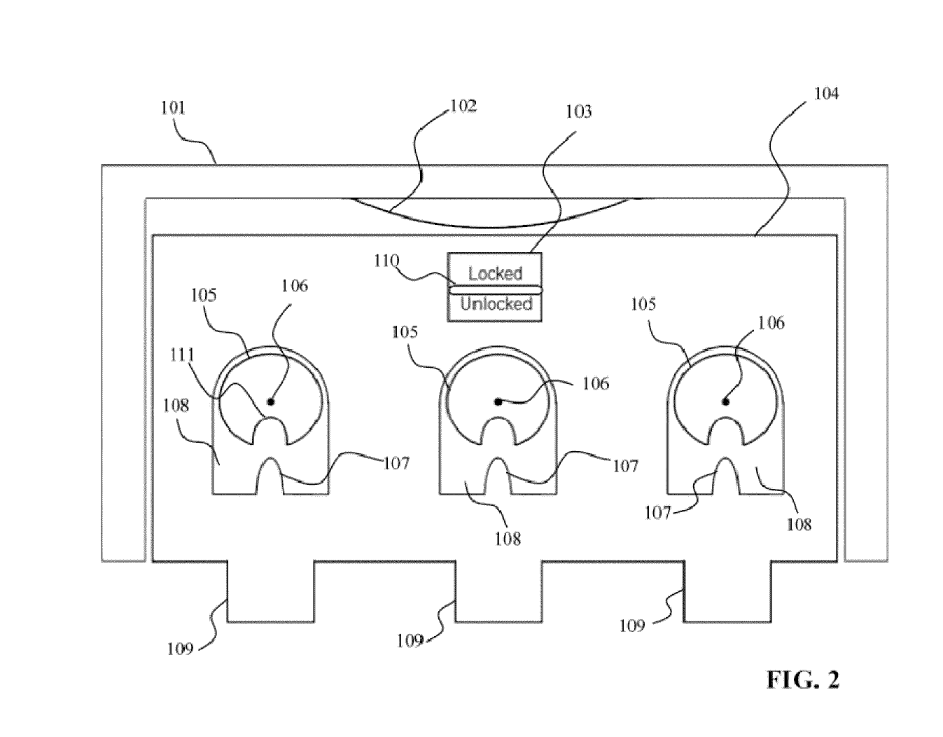

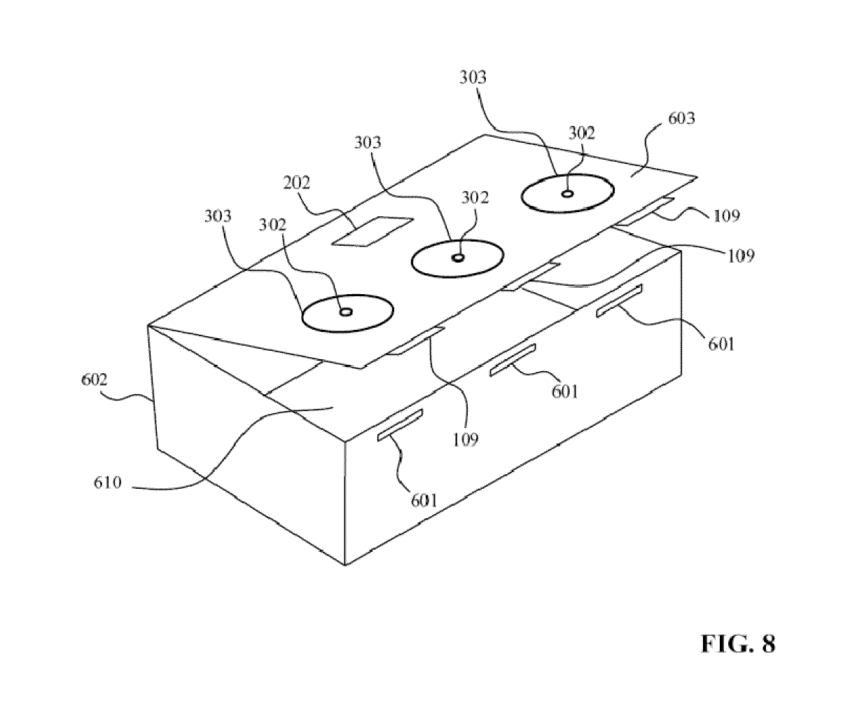

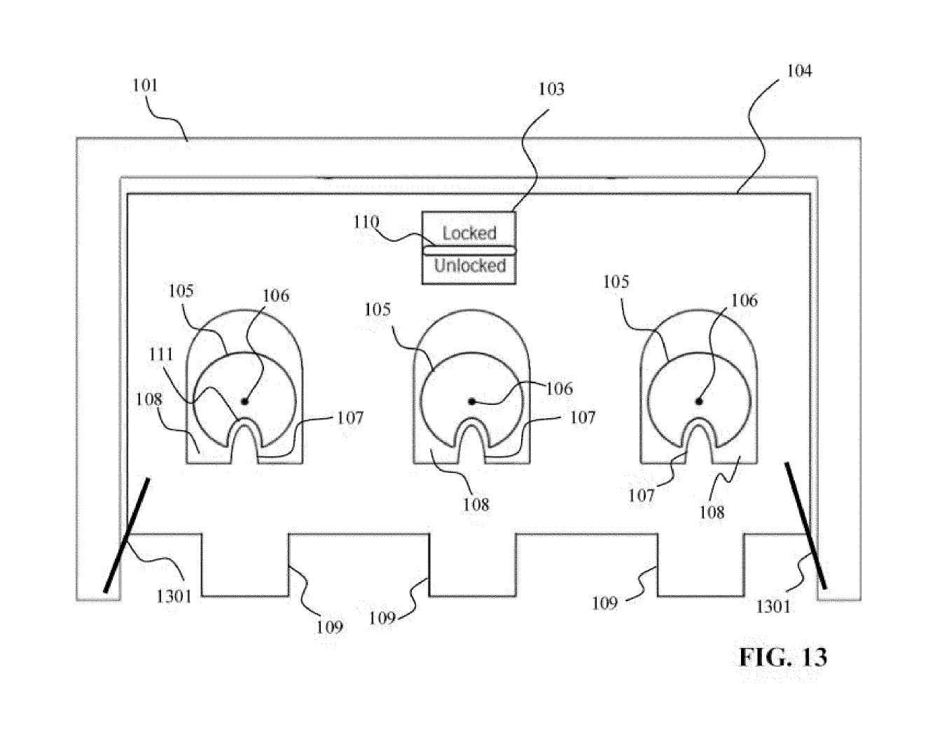

FIG. 2 and FIG. 3 illustrate a top plan view of the disposable and/or recyclable combination lock in the unlocked position in accordance with present application. In this position all three of the notches 111 of the combination discs 105 are aligned with their corresponding tongues 107. Therefore, the locking latch plate 104 can move freely backward (unlocked position) which results in the locking latches 109 being able to move out from the plurality of the locking latch holes 601 that are illustrated in FIGS. 8-10. This unlocking position enables opening a lid of a box, a container, or a package that is attached to the combination lock as illustrated in FIGS. 8, 9, and 10. In general, the box, the container, the package and similar container are referred to as the lockable article. The spring element 102 is pressed when the locking latch plate 104 is moved backward, resulting in a pressed-spring mechanism that pushes the locking latch plate 104 forward (locked position). The locking latch plate knob 110 can be used as a handle to move the locking latch plate 104 forward and backward. In this exemplary embodiment, the spring element 102 is illustrated as a bent, arch-shaped, or bow-shaped spring that when pressed with a force produces a force against the pressing force. Various types of spring elements 102 having different shapes made from various materials can substitute the spring element 102 and the functionality of the combination lock is independent of the type and the shape of the spring element 102. For example, a plurality of torsion springs can be used as the spring element 102. Elastic or rubber bands 1301 can also be used to force the locking latch plate 104 to the locked position. Such elastic or rubber bands connect the locking latch plate 104 to the outer case 101 as illustrated in FIG. 13.

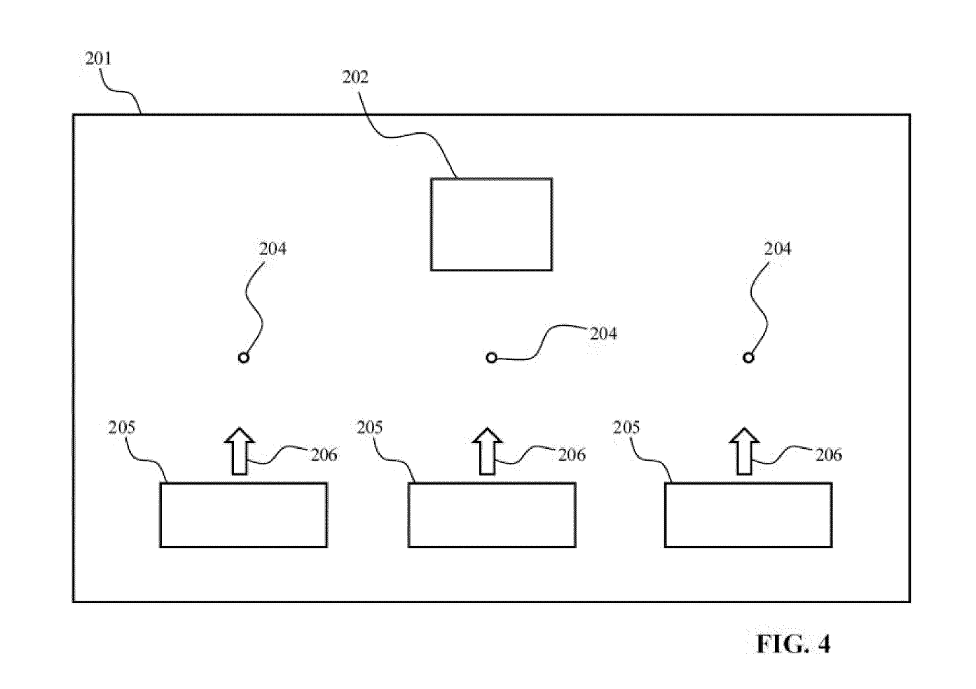

FIG. 4 illustrates a top plan view of an exemplary external lid 201 that the disposable and/or recyclable combination lock can be assembled on in accordance with present application. The external lid 201 can be a flip-open lid of a box, a lid of a mailer, a lid of an envelope, a lid of a container, or a lid of a product's packaging. The external lid 201 includes a plurality of external lid holes 204 and an external lid lock status slot 202 that are produced by cutting, for example, die cutting or punching. The external lid 201 may further include a plurality of combination dial position indicators 206, and a plurality of external lid labels 205. The external lid lock status slot 202 can be a die cut window that is intended to allow a user to observe the status of the lock status label 103 that shows the position of the locking latch plate 104. Additionally, the external lid lock status slot 202 provides an opening for the locking latch plate knob 110 to be accessed by a user to move the locking latch plate 104 forward and backward in order to lock or unlock the combination lock. Each combination dial position indicator 206 indicates a rotational position of the corresponding combination disc 106 that is securely attached and is freely rotated with a plurality of combination dials 301 around the external lid holes 204. Each of the external lid holes 204 is used to provide a path for a rotating shaft 302 to secure the combination disc 106 around an axis. In one exemplary embodiment, each external lid label 205 may provide a clue or a question for unlocking the corresponding combination disc 106, and can be printed on the external lid 201. For example, a question may be provided on the external lid label 205 for which the right answer can lead a user to place the corresponding combination disc 106 in the unlocking position. In another exemplary embodiment, each combination dial 301, when positioned in the unlocking position, may also provide clues for unlocking another combination dial 301. In some exemplary embodiments, where the combination key is made of transparent recyclable and/or disposable materials a user can observe the combination disc 106 and rotate it to place it in the unlocking position.

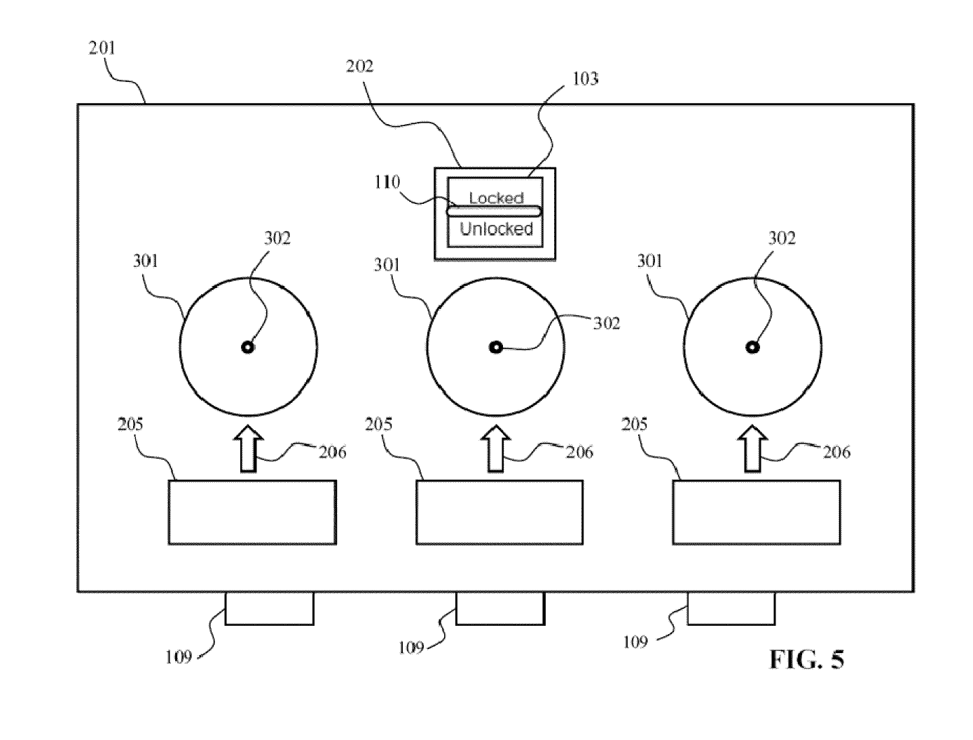

FIG. 5 illustrates a top plan view of the external lid 201 after assembling the disposable and/or recyclable combination lock in accordance with present application. The plurality of combinations dials 301 of generally circular configuration each having a plurality of combination indicia (not shown here) equally spaced about its periphery are assembled on the external lid 201. Each combination dial 301 is adapted to rotatably fit and connect to each combination disc 106 using the rotating shafts 302. When each of the combination dials 301 is turned clockwise or counter clockwise, the corresponding combination disc 106 also turns clockwise or counter clockwise. In order to unlock the combination lock, the notch 111 of the combination disc 106 must be aligned with the tongue 107 of the locking latch plate 104 and then the locking latch plate 104 must be moved using the locking latch plate knob 110 to move the plurality of locking latches 109 to the unlocked position. The locking latch plate knob 110 can be replaced by similar means that can serve as a handle to move the locking latch plate 104, for example, a hole on the locking latch plate 104 can be used as a grip for a finger to move the locking latch plate 104.

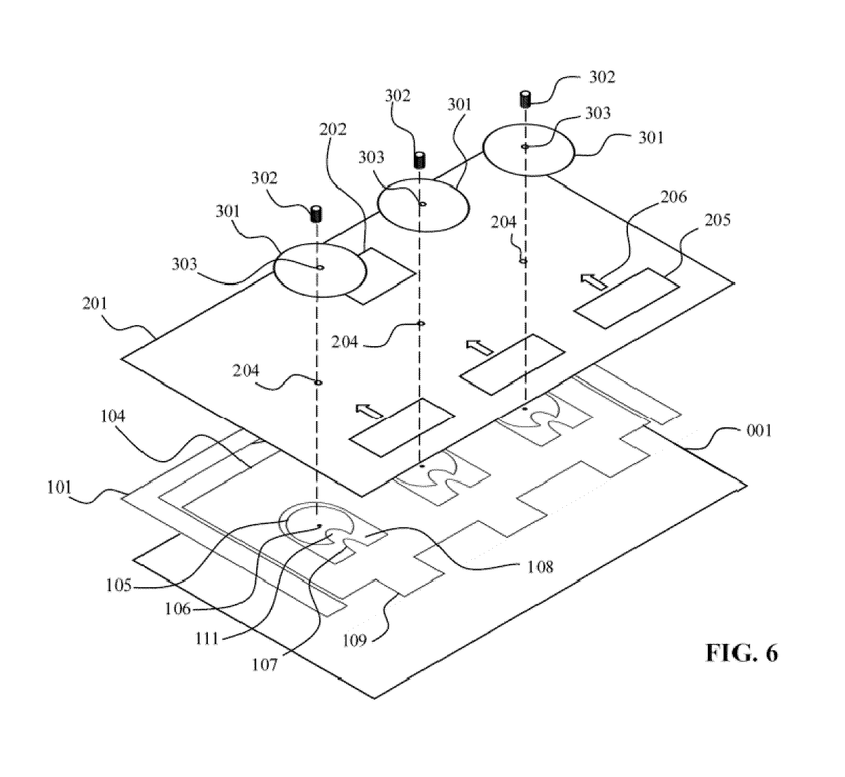

FIG. 6 illustrates an exemplary perspective, fragmentary, and exploded view of the disposable and/or recyclable combination lock sandwiched between a back cover plate 001 and the external lid 201 in accordance with present application. The outer case 101 is retained in a fixed position between the back cover plate 001 and the external lid 201 to allow the locking latch plate 104 to move forward and backward between the back cover plate 001 and the external lid 201. The disposable and/or recyclable combination lock comprises of a first layer including the locking latch plate 104, the plurality of combination discs 105, the lock status label 103, and the locking latch plate knob 110. The first layer is sandwiched between a second layer including the back cover plate 001 and a third layer including the front cover 002. The plurality of combination dials 301 are connected to the rotating shafts 302 on the front cover 002.

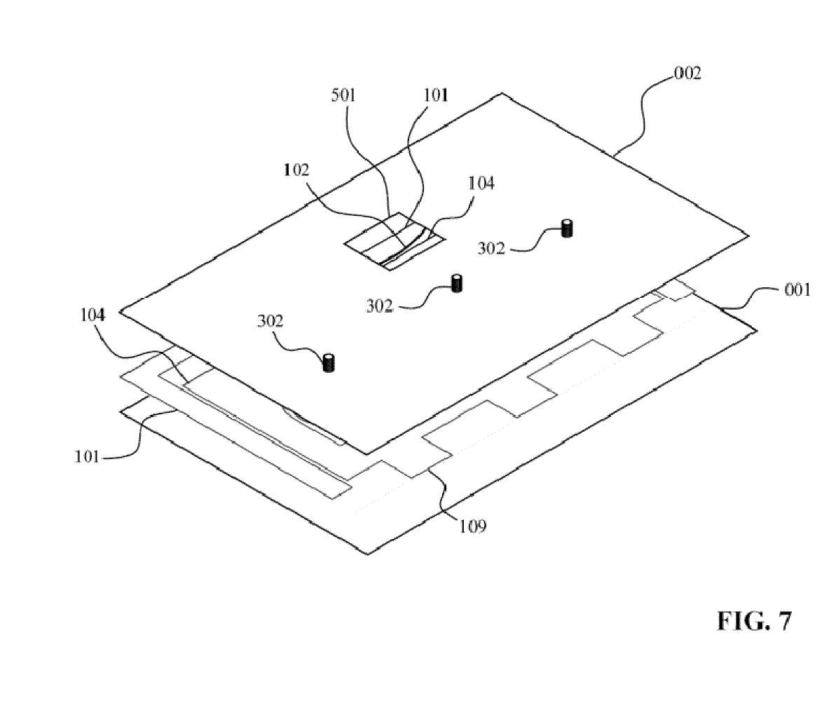

FIG. 7 illustrates a perspective, exploded, and fragmentary view of some other embodiment of the disposable and/or recyclable combination lock having a front cover plate 002 and the back cover plate 001 in accordance with present application. In this exemplary embodiment, the combination lock is sandwiched between the front cover plate 002 and the back cover plate 001 to provide an advantage of easy manufacturing and assembly convenience. The rotating shafts 302 illustrated on the front cover plate 002 are connected to the combination discs 105. A lock status window 501 is cut on the front cover plate 002 to provide an opening for the locking latch plate knob 110 and the lock status label 103 to be accessed from the front cover plate 002. The front cover 002 and the back cover 001 can be made of the same or different material from the first layer. It should be noted that the front cover 002 and the back cover plate 001 are sheets of recyclable and disposable material of the same thickness or different thickness. The outer case 101 is embedded between the back cover plate 001 and the front cover plate 002 in a fixed position. The embedding can be achieved by gluing, stapling, heat sealing, sealing, or any similar methods. The front cover plate 002 can be the same size or a different size from its flat surface with respect to the back cover plate 002. A plurality of cuts are performed on the front cover plate 002. The cuts include, but are not limited to, a plurality of holes (not shown here) to provide holes for the plurality of rotating shafts 302 that connect the plurality of combination dials 301 to the plurality of combination discs 105 through the rotating shafts 302. Additionally, the front cover plate 002 includes the lock status window 502 that is made by cutting a window to provide access to the lock status label 103 and the locking latch plate knob 110.

The combination lock having the front cover plate 002 and the back cover plate 001 can be integrated with and/or assembled on a lid or a main body of various types of containers, boxes, and envelopes as described later in this application. It should be noted that the front cover plate 002 is not necessarily required for the combination lock to be functional and it only provides a convenience of separate manufacturing of the combination lock (i.e., as original equipment manufacturer or OEM and pre-made combination lock) and easy assembly on various boxes and containers later on. Another advantage it provides is that the combination lock can be assembled on and can be adapted to various types and sizes of packaging and boxes.

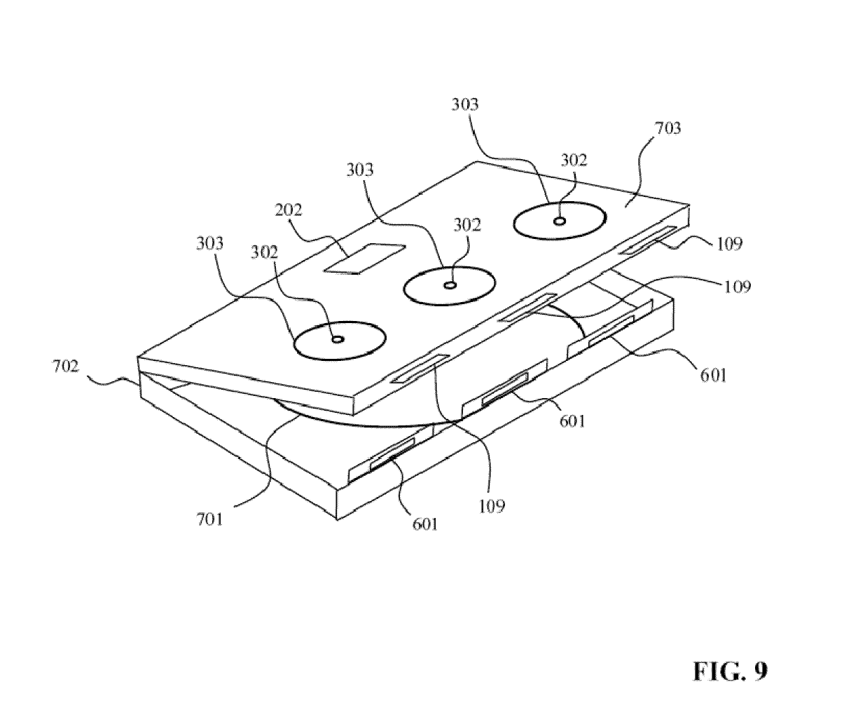

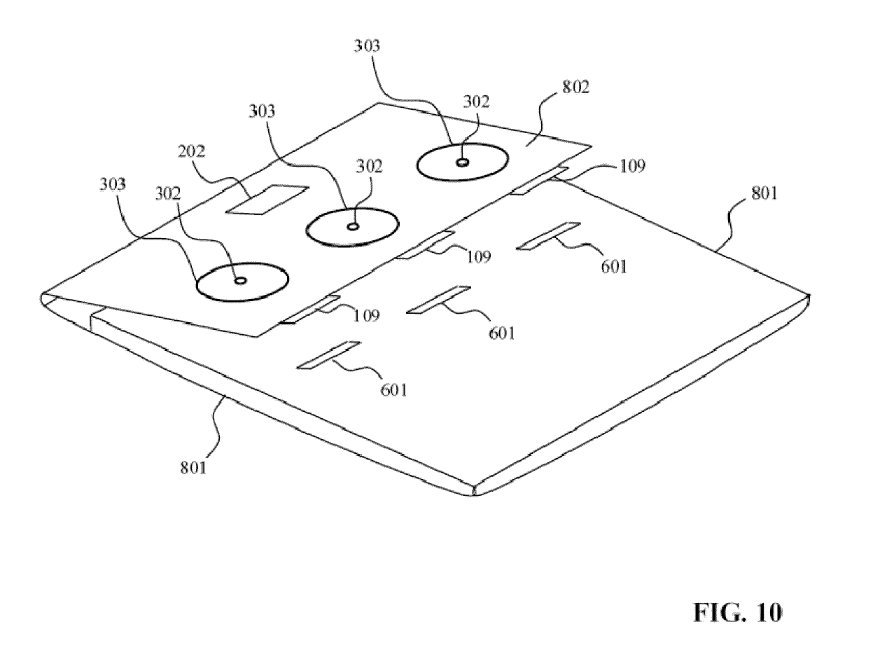

FIG. 8 illustrates a perspective view of a container 602 after assembling the disposable and/or recyclable combination lock in accordance with present application. In this exemplary embodiment, the combination lock is assembled on a container lid 603 of the container 602 having an interior region 610. The container is preferably made from the same material as the combination lock. In this embodiment, the front cover plate 001 may be included in the combination lock but the combination lock's functionality is not dependent on the front cover plate 001 as the container lid 602 can serve as the front cover plate 001. The plurality of locking latch holes 601 are cut or punched on the container 602 as illustrated in FIG. 8 such that the locking latches 109 of the combination lock can be inserted into them in the locked position. When the combination lock is unlocked (i.e. all of the combination discs 105 are placed in a position in which the locking latch plate 104 can be moved backward) the locking latch plate knob 110 (not shown in FIG. 8 for simplicity of illustration) that is accessed via the external lid lock status slot 202 can be used to move the locking latch plate 104 having locking latches 109 to free the locking latches 109 from the locking latch holes 601. The free position or unlocked position is a position where the locking latches 109 are not engaged with the locking latch holes 601. After freeing the locking latches 109 from the locking latch holes 601, the container lid 603 can be opened and the contents of the container 602 can be accessed. FIGS. 9 and 10 illustrate perspective views of a compact disc case 702 and an envelope 801 after assembling the disposable and/or recyclable combination lock in accordance with present application. The operation of the combination lock is similar to the operation of the combination lock that is attached to the container 602 as explained above. Additionally, the combination lock can be assembled on a cover of a book to lock the book. In each of the examples described in this application, the combination lock can be made from the same material that the container has been made from. For example, in the case of the container 602 that is made of paper board, the combination box can be also made from the paper board. Similarly, for the compact disc case 702 that is made of a recyclable plastic, the combination lock can be made from the same type of plastic with a similar thickness. Similarly, for the envelope 801 that is made from cardstock, the combination lock can be made from the same type of cardstock. In other examples not described in this application, the combination lock and the article that the combination lock is attached to can be made from different materials that are disposable and/or recyclable. The combination lock can also be used in child-resistant unit dose packaging containing a tray carrying a plurality of tables or like items for dispensing from the container body.

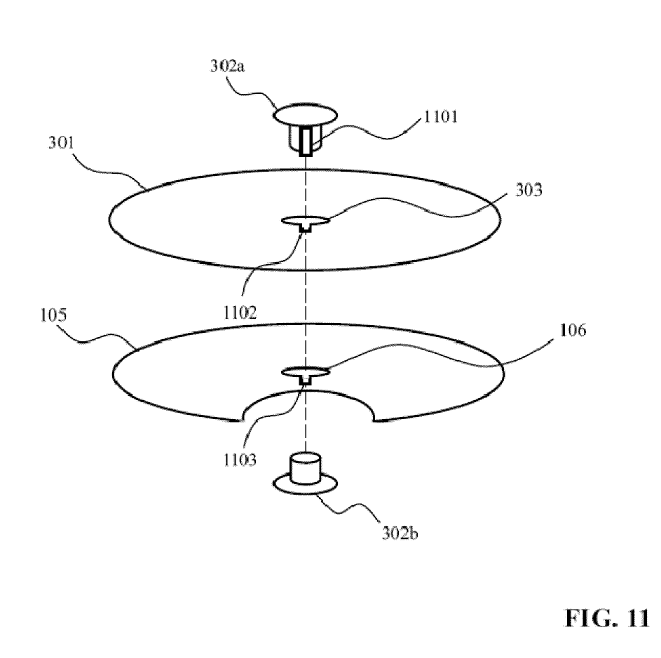

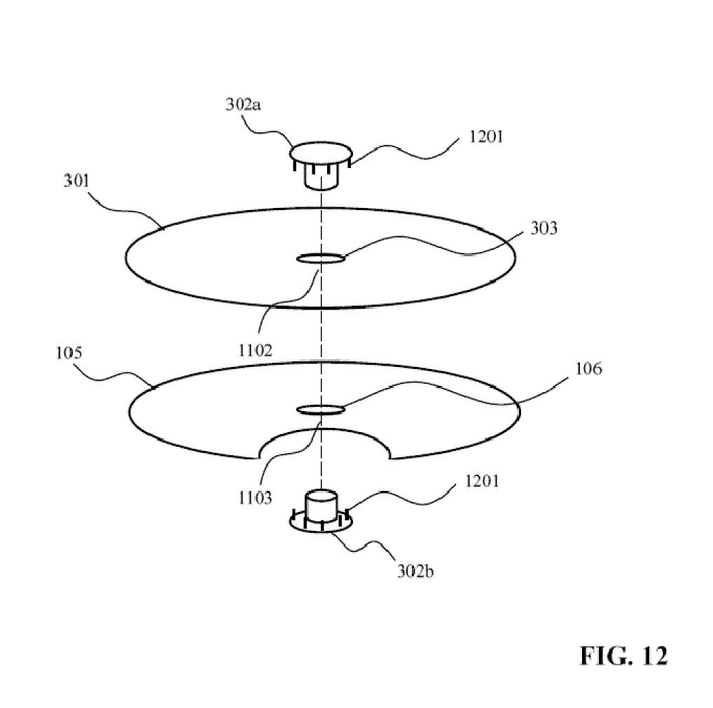

FIG. 11 illustrates a perspective and fragmentary view of the combination dial 301, the combination disc 105, and the rotating shaft 302 of the disposable and/or recyclable combination lock in accordance with present application. The front cover layer 002 and/or the external lid 201 in between the combination dial 301 and the combination disc 105 are not depicted in FIG. 11 for simplicity of illustration. In one exemplary embodiment, the rotating shaft 302 is made of an upper part 302a and a lower part 302b. The upper part 302a has a rotating shift tongue 1101 that fits into a combination dial notch 1102 of the combination dial 301 and a combination disc notch 1103 of the combination disc 105 and allows alignment of the combination disc 105 with the combination dial 301. This results in rotation of the combination disc 105 to be restricted with rotation the combination dial 301 to prevent the combination disc 105 from displacement. Similar mechanisms to prevent misalignment of the combination dial 301 and combination disc 105 may be used. The combination disc 105 can be the same size or a different size from the combination dial 301. Also, the plurality of combination dials 301 can have different shapes and sizes and they do not necessarily have a single identical size and/or shape. Additionally, more than one tongue or notch, preferably two and more preferably three or more tongues and notches may be used to fix the movement of combination dial 301 and the combination disc 105. It should be noted that the rotating shafts 302 can be eyelets, two part eyelets, prong eyelets, grommets, grommets with teeth, self-piercing grommets, two-piece grommets or similar pieces that can perform the same functionality. For example, FIG. 12 illustrates a perspective and fragmentary view of the combination dial 301, the combination disc 105, and the rotating shaft 302 of the disposable and/or recyclable combination lock where the rotating shaft includes rotating shaft teeth 1201 to secure rotation of the combination dial 301 and the combination disc 105 simultaneously and in synchrony with respect to each other.

It should be noted that in the exemplary embodiments that are described in this application, the combination lock is assembled on the lid of a container, box, mailer or similar packages, and the locking latch holes 601 are provided on the container, box, mailer or similar packages, respectively. However, similarly, the combination lock can be assembled on the container, box, mailer or similar packages, and the locking latch holes 601 can be made on the lid of the container, box, mailer or similar packages, respectively.

Further, it should be noted that the planar components of the combination lock as disclosed in this application, for example, outer case 101, locking latch plate 104, combination discs 105, combination disc holes 106, combination disc die cuts 108, locking latches 109, and combination dials 301 can be preferably manufactured by die cutting flat sheets of disposable and/or recyclable material. However, similar methods, for example, rotary die cutting, clinking, cutting plotters, laser cutters, utility knives, and/or scissors, can be also used as the functionality of the combination lock is independent of the production method. For example, if plastic is used as the recyclable material, plastic molding procedures can also be used to produce the components of the combination lock that have flat geometry.

Examples of disposable and/or recyclable materials are provided in McGraw-Hill Recycling Handbook, 2nd Edition By Herbert Lund (2001) which are incorporated herein by reference in its entirety. Cardboards sheets, compressed papers sheets, processed papers sheets, paper board sheets, chip board sheets in various colors and sizes can be used to make the disposable and/or recyclable combination lock. Examples of paper-based materials are provided in the Handbook of Paper and Board (H. Holik), Wiley-VCH Verlag GmbH & Co. KGaA, Weinheim, FRG (2006) which are incorporated herein by reference in its entirety. Recyclable metal sheets having flat geometry can also be used to make the disposable and/or recyclable combination lock. Recyclable wood sheets, either processed or unprocessed, can also be used to make the disposable and/or recyclable combination lock. Further, transparent disposable and/or recyclable material can also be used.

The thickness of the sheets that are used to fabricate various layers of the disposable and/or recyclable combination lock are between 0.1 mm to 2 mm, preferably from 0.1 mm to 3 mm, and more preferably from 0.1 mm to 5 mm. The sheets of disposable and/or recyclable materials can be made from a single type of disposable and recyclable material or they can be made from a combination of disposable and recyclable materials. For example, the sheet of disposable and/or recyclable material may have different layers including different disposable and/or recyclable materials. Examples of such multi-layered sheets of disposable and recyclable material include, but are not limited to, plastic coated paper, plastic coated cardboard, PET coated papers, aluminum foil coated paper, or sheets of paperboard and cardboard with various types of coatings (i.e., UV coating, water resistance coating, or similar coatings) to protect printed materials on them.

The disposable and/or recyclable combination lock can be used in various applications. Some exemplary methods for using the disposable and/or recyclable combination lock are described in the following. It should be noted that the disposable and/or recyclable combination lock can be used in similar applications and the provided examples are not aimed to limit the methods for which the disposable and/or recyclable combination lock can be used.

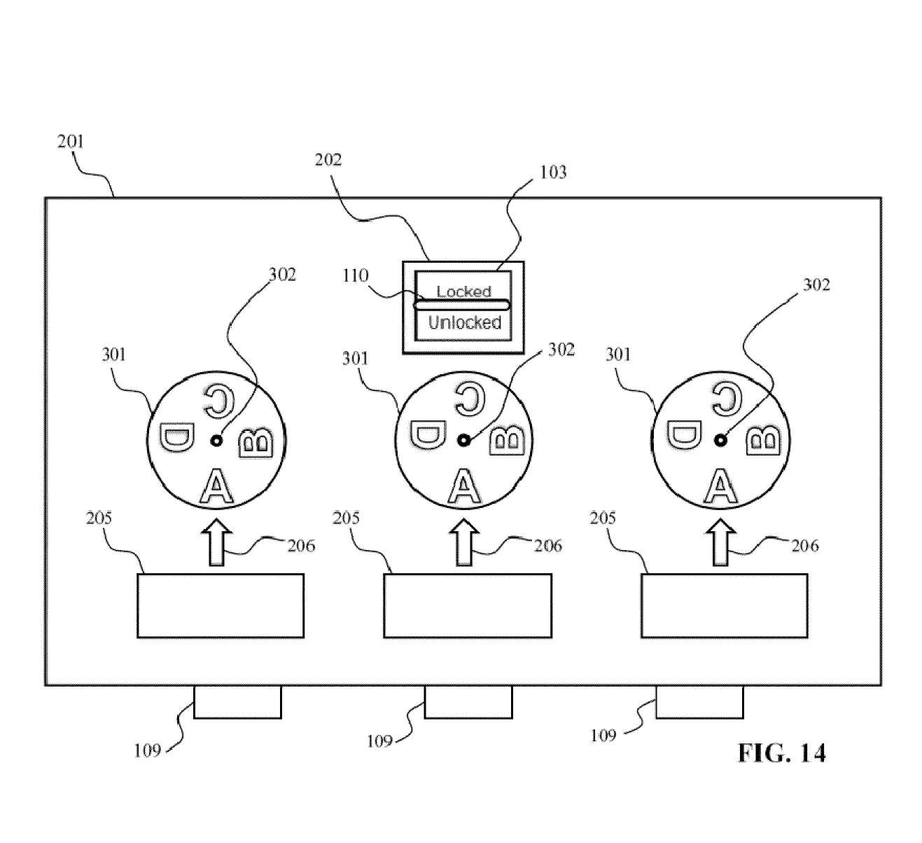

A product for sale can be provided in a package with the disposable and/or recyclable combination lock such that for opening the packaging, a consumer needs to adjust the plurality of combination dials 303 to unlock the combination lock. In this exemplary method, the combination of indicia that unlock the combination lock can be related to the brand name of the design, or manufacturing company. For example, as shown in FIG. 14 the combination that unlocks the combination lock is “AAA” can be the brand name of a company that sells a product that is in the package with the combination lock.

Additionally, letters or important documents can be delivered inside an envelope secured with the disposable and/or recyclable combination lock using a carrier that is barred from accessing the content of the envelope (adding tamper evidence to the envelope or packaging). In order to access the content of the envelope, a carrier needs to know the combination to the combination key or tear the envelope to access the content which can result in evidence of tampering. The unlocking combination to unlock the combination key can be communicated between a sending party and a receiving party via a phone conversation or another mode of communication.

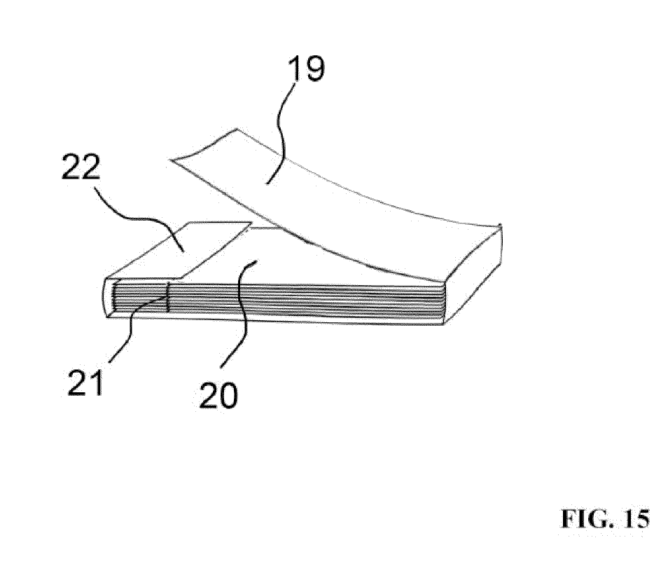

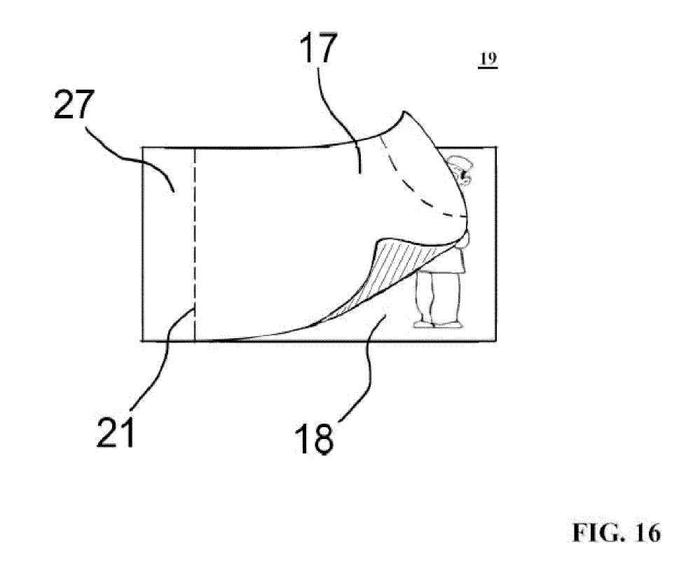

In particular, a plurality of rewards, a plurality of toys, and/or a plurality of child-related items such as arts and crafts items for a child can be provided in a package or a box with the disposable and/or recyclable combination lock such that for unlocking the package or the box, a child needs to adjust the combination lock to a combination that unlocks the combination lock. The unlocking clues for the combination lock can be provided in an educational book that accompanies the package or the box. In a preferred method, a box with the combination lock is provided to a child and the child is encouraged to read a book provided with the box with the combination lock in order to unlock the box and access a plurality of items in the box. Further, a series of flash cards can be used instead of the book to provide clues for unlocking the combination lock that is attached to the box. FIG. 15 illustrates a perspective view of a booklet having a plurality of flash cards 20 for which each provides a clue to unlock one combination dial of a disposable and/or recyclable combination lock in accordance with present application. The booklet has a plurality of flash cards 20 with perforations 21 that are bundled and can be detached from the booklet. The booklet has a cover 19 that is wrapped around the flash cards 20. The booklet cover 19 is made in a way in that it can be closed by placing the booklet cover below a second section 22 of the booklet cover 19. FIG. 16 illustrates a perspective view of each flash card 19 with perforation 21 having a flash card cover 17 and a printed flash card 18. The flash card 19 can be detached from a flash card bottom 27 that is used to bundle the flash cards 19. When the flash card cover 17 is removed, the printed flash card 18 that has clues to unlock a disposable and recyclable combination lock can be read and accessed. Then, the child can unlock each combination dial of the combination lock that is correlated with each printed flash card 18.

In another embodiment, each combination dial that is positioned in the unlocking position can provide a clue to position the next combination dial in the unlocking position. For example, the combination lock having five combination lock dials can be unlocked by starting to unlock the first combination dial and unlocking the second combination dial based on the indicia that the unlocked first combination dial provides, the third combination dial based on the second combination dial, the fourth combination dial based on the third combination dial, and the fifth combination dial based on the fourth combination dial. Accordingly, the combination lock can be unlocked by sequentially unlocking each combination dial based on a clue obtained by a previous combination dial. For example, the first external lid label 205 can provide a question (2+2=?). The answer to unlock this combination dial is 4. The child can place the first combination dial on 4. The second external lid label 205 can provide a question (the answer to the first question+2=?). The correct answer to unlock the second combination dial is 6. However, the child need to first find the correct answer to the first combination dial before being able to unlock the second combination dial.

It is believed that the foregoing description of the preferred embodiments of the invention is sufficient in detail to enable one skilled in the art to make and use the invention without undue experimentation. However, it is expressly understood that the detail of the elements comprising the embodiment presented for the foregoing purpose is not intended to limit the scope of the invention in any way, in as much as equivalents to those elements and other modifications thereof, all of which come within the scope of the invention, will become apparent to those skilled in the art upon reading this specification. Thus, the invention is to be broadly construed within the full scope of the appended claims.

1. A disposable and/or recyclable combination lock comprising:
a plurality of combination dials that lock or unlock said disposable and/or recyclable combination lock, each one of said plurality of combination dials having a corresponding unlocking dial position and being rotatably adjustable to its corresponding unlocking dial position; and
a locking latch plate including a plurality of locking latches that is movable between a locked position and an unlocked position when all of said plurality of combination dials are in their corresponding unlocking dial positions, and is fixed and non-movable in a locked position when at least one of said plurality of combination dials is in its corresponding unlocking dial position, wherein
said disposable and/or recyclable combination lock is attached to a disposable and/or recyclable lockable article including a plurality of locking latch plate holes, an interior region, and a lockable lid,
said plurality of locking latches of said locking latch plate in said locked position are engaged with said plurality of locking latch plate holes and prevent said lockable lid from being opened to gain access to said interior region, and said plurality of locking latches of said locking latch plate in said unlocked position are not engaged with said plurality of locking latch plate holes and allow said lockable lid for being opened to gain access to said interior region,
said disposable and/or recyclable combination lock has a substantially flat geometry, and
the disposable and/or recyclable combination lock is made of recyclable and/or disposable materials.

2. The combination lock according to claim 1, wherein
said locking latch plate further includes a plurality of combination disc cuts that provide a plurality of empty spaces on said locking latch plate and a plurality of tongues on said locking latch plate.

3. The combination lock according to claim 2, further comprising:
a plurality of combination discs, each one of said plurality of combination discs having a notch is placed inside its corresponding combination disc cut and is connected to its corresponding combination dial from said plurality of combination dials such that a rotation of each one of said plurality of combination dials rotates each corresponding combination disc simultaneously and in synchrony;
a locking latch plate knob that is used as a handle to move said locking latch plate between said locked position and said unlocked position;
an outer case that provides an axial path for said locking latch plate to move between said locked position and said unlocked position and retains said locking latch plate in said axial path; and
a spring element between said outer case and said locking latch plate that forces said locking latch plate into said locked position, wherein
in said unlocking dial position said notch of each one of said plurality of combination discs fits into said tongue of each corresponding combination disc cuts when the locking latch plate is moved to said unlocked position, and
in positions other than said unlocking dial position said tongue of each of said plurality of combination disc cuts prevents said locking latch plate from moving to said unlocked position.

4. The combination lock according to claim 3, further comprising:
a back cover plate that sandwiches said locking latch plate, said plurality of combination discs, said outer case, and said spring element between said lockable lid and said back cover plate, wherein
said outer case is fixed between said back cover plate and said lockable lid,
said locking latch plate is movable between said locked position and said unlocked position in said axial path, and
each of said plurality of combination discs freely rotates around each of a plurality of combination disc holes.

5. The combination lock according to claim 4, wherein said locking latch plate, said plurality of combination dials, said plurality of combination discs, and said outer case are made of recyclable and/or disposable materials and are of a same predetermined thickness.

6. The combination lock according to claim 5, where in the combination dials have a substantially circular geometry.

7. The combination lock according to claim 6, wherein each of said plurality of combination dials are connected to corresponding combination disc with a rotating shaft.

8. The combination lock according to claim 7, wherein said unlocking dial position of at least one of said plurality of combination dials provides a clue for another unlocking dial position of another combination dial of said plurality of combination dials.

9. A disposable and/or recyclable combination lock comprising:
a first layer including:
a locking latch plate having a plurality of locking latches and a plurality of locking latch plate cuts,
a plurality of combination discs,
an outer case, and
a spring element;
a second layer including:
a front cover plate having a plurality of front cover plate holes and a front cover slot; and
a third layer including:
a back cover plate, wherein
the first layer is sandwiched between the second layer and the third layer,
said disposable and/or recyclable combination lock is attachable from said second layer to a lockable lid of an article having a plurality of locking latch plate holes and an interior region that is accessed by removing said lockable lid,
each one of a plurality of combination dials are connected to its corresponding combination disc via each one of a plurality of rotating shafts,
said disposable and/or recyclable combination lock has a substantially flat geometry, and
the disposable and/or recyclable combination lock is made of recyclable and/or disposable materials.

10. The combination lock according to claim 9, wherein said locking latch plate, said plurality of combination dials, said plurality of combination discs, and said outer case are of a same predetermined thickness.

11. The combination lock according to claim 9, wherein said unlocking dial position of at least one of said plurality of combination dials provides a clue for another unlocking dial position of another combination dial of said plurality of combination dials.

12. A method for accessing a plurality of items in said interior region of said disposable and/or recyclable lockable article locked with said disposable and/or recyclable combination lock according to claim 1, comprising:
providing said disposable and/or recyclable lockable article locked with said disposable and/or recyclable combination lock that includes said plurality of items in said interior region to a user;
providing a book or a plurality of flash cards to said user;
finding a plurality of clues by said user in said book or said plurality of flash cards;
adjusting said plurality of combination dials to said unlocking position based on said plurality of clues;
opening said lockable lid of said disposable and/or recyclable article; and
accessing said plurality of items in said disposable and/or recyclable lockable article.
